(19) United States
(12) Patent Application Publication
(10) Pub. No.: US 2025/0103269 A1
(43) Pub. Date: Mar. 27, 2025

(54) METHODS AND SYSTEMS FOR COMBINING MULTIPLE DISPLAY DEVICES TO FORM ONE COMBINED DISPLAY DEVICE

(71) Applicant: Leigh M. Rothschild, Miami, FL (US)

(72) Inventor: Leigh M. Rothschild, Miami, FL (US)

(21) Appl. No.: 18/473,640

(22) Filed: Sep. 25, 2023

(51) Int. Cl. G06F 3/14; G06F 3/0484

(52) U.S. Cl. CPC G06F 3/1446; G06F 3/0484; G06F 3/1407

(57) ABSTRACT

The present disclosure discloses methods and systems for combining multiple display devices to form a combined display device, referred to as a display wall. Each display device includes a controller embedded within the display device, compatibility pins and a user interface. The method includes checking compatibility of the multiple display devices before displaying content on the combined display device. Based on the check, a user interface is presented to the user with one or more options for configuring the display device. The user provides an input and based on the input from the user, the combined display device is configured to display content according to requirements, preferences and/or input from the user. This way, the user can enjoy viewing content on a large screen by combining multiple display devices, without requiring him to buy a single expensive device.

### TECHNICAL FIELD

The present disclosure relates to the field of display devices, specifically, the disclosure discloses methods and systems for combining individual multiple display devices to form or create a combined display device.

### BACKGROUND

In the last few years, people's habit of consuming content and how they like to view the content has changed and it is continuously evolving. Along with this, their habits of purchasing those devices have evolved. For example, they like to have larger displays for viewing content for all types of devices whether they are mobile devices, tablets, or televisions. With more streaming content, most consumers have home theaters, but if do not have them, they want to create larger display screens to create that home theater atmosphere or environment. This is not just in television but also applicable to other computer displays as well. Trends have also changed in the last 5-7 years, when TV display prices have dropped dramatically. As a result, a consumer can easily buy a 65-inch display and can also afford an 85-inch display. But prices of devices from 90 inches or 120 inches are huge, for example, they are priced at USD 100K. It becomes difficult for most consumers to buy that size but the wish to view content on larger display screens remains constant. Looking at the consumer's interest, mobile phones and tablet manufacturers developed interests in large display screens along with TV manufacturers.

Several trends are notable in the large display area. One such common and popular trend is infinity screens, i.e., edge-to-edge screens where display devices no longer have a border which makes the viewing easy and smooth for the consumer. For example, the consumer can view from one side to another and from top to bottom without a border. Another such trend is foldable devices. The foldable devices can open, expand, and can fold into a larger display area. These devices are useful in the sense they become compact with a large display, but these devices are expensive, vulnerable to breakage and difficult to put in a protective case. The most popular and easiest way to view content on a larger display is by combining multiple display screens. For example, a consumer can combine multiple screens, say four screens, and hardware and software process the input source and divides content equally between the four display screens. However, in existing known setups, video wall controllers are external hardware controllers which adds another layer of complexity to existing components of the multiple display screens. Many times, this means, the consumer has to compromise on the aesthetic part. Additionally, there is a video wall system from the company “Samsung” that allows combining multiple display screens, however, in that existing video wall solution, all display screens have to be of the same manufacturer, same size, same features, functions, or even same type. This poses an additional limitation on the users to choose the same manufacture, size that is actually difficult as everyone's choices/desires/preferences change with time. In this view, there is a need for improvised methods and systems for allowing users to combine multiple display screens easily, in a user-friendly manner and yet at an affordable price.

### SUMMARY

According to the disclosure, a method for allowing a user to combine a new display device with at least one prior existing display device to make a single combined display device, is disclosed. Each display device of the combined display device includes a controller embedded within the display device, and further includes a plurality of compatibility pins on one or more sides of the display device. The method includes receiving the new display device to one side of the at least one prior existing display device via the plurality of compatibility pins. The new display device is added to the at least one prior existing display device to make a combined display device. Thereafter, compatibility of the new display device is checked with the at least one prior existing display device, based on at least one pre-defined parameter. Based on the compatibility check, a user interface is provided on at least one display device of the combined display device with at least one option for selection. An input from the user is received on the at least one displayed option. Finally, content is displayed on the combined display device according to the input from the user, requirements and/or preferences of the user. This way, the method allows the user to view content on the larger combined display device according to his requirements and/or preferences.

According to further aspects, a display wall is disclosed. The display wall includes a plurality of display devices forming a combined display device, wherein each display device includes a controller, at least one compatibility pin and a user interface. The controller is embedded inside the display device for controlling functionality of the display device. The at least one compatibility pin is provided on at least one side of the display device such that at least one compatibility pin is communicatively coupled to controller inside the display device, wherein the at least one compatibility pin provides connection between the plurality of display devices and compatibility between the plurality of display devices. Finally, a user interface and/or menu is provided for displaying at least one message and further allowing a user to provide an input to configure the combined display device to view content according to his requirements and/or preferences.

According to additional aspects, a method for configuring a combined display device including multiple display devices which are connected to each other via compatibility pins is disclosed. The method includes checking for compatibility of each display device in connection, based on at least one pre-defined parameter. Based on the compatibility check, a user interface and or menu is displayed on at least one display device of the combined display device with at least one option for configuring the combined display device. Then, an input from a user is received on the at least one displayed option. Finally, the combined display device is configured to display content according to the requirements and/or preferences of the user and/or other users.

The present disclosure provides a flexible, modular, and user-friendly approach to form a huge display wall, where the users can add multiple display devices as and when they like and/or can afford. For example, if the users have money to spend, they can buy all display screens at once and form a huge display wall. In another example, if the users have budget constraints, they can first buy one display device and later say after a year, they can buy another display device and add to the existing display device, and then more display devices can be added after some time, for example, 6 months. The disclosure solution considers users dynamic choices/desires as they may change with time. For example, the users do not have to worry about buying all display devices from the same manufacturer, or these display devices do not necessarily need to have same features, functions, configurations, or the like. For example, if a user has a TV from a manufacturer say, Samsung and later he wishes to buy a display device from another TV manufacturer, say, Toshiba and wishes to add to the existing display device from Samsung, the disclosure allows the user to do so without any limitation. The multiple display devices are combined to provide a seamless user experience.

A display wall, formed by combining multiple display devices, is an output device i.e., hardware that displays content to one or more users according to their choices/preferences. The display wall may include hardware and/or software components required for implementing the disclosure. For example, the display wall includes one or more hardware components such as display devices having display screens, compatibility pins, ports, memory, and software components such as a controller, user interface, etc. The hardware and software components work in tandem with each other such that content of users' choices and/or preferences is displayed to them. The content displayed to the users is tangible in nature and hence the solution proposed in the disclosure provides tangible output and is not an abstract idea.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute part of this specification, illustrate embodiments of the disclosure and together with the description serve to explain the principles of the present disclosure. The embodiments illustrated herein are presently preferred, it being understood, however, that the disclosure is not limited to the precise arrangements and instrumentalities shown, wherein:

FIGS. 1A, 1B, 1C and 1D illustrate exemplary environments in which various embodiments of the disclosure can be practiced.

FIG. 2 is a system illustrating a combined display device including various components for implementing the disclosure.

FIGS. 3A, 3B, showcase exemplary compatibility pins provided on an exemplary display device, whereas FIG. 3C showcases two display devices in connection via the compatibility pins.

FIG. 4 is a method flowchart for allowing a user to combine multiple display devices to form a combined display device.

FIGS. 5A-5B show exemplary user interfaces displayed on display devices according to various configurations.

FIG. 6 is a method flowchart for checking compatibility of multiple display devices before content is displayed.

FIGS. 7A-7C showcase a combined display device displaying content according to various configurations.

Like reference numerals refer to like parts throughout the several views of the drawings.

### DESCRIPTION

### Non-Limiting Definitions

In various embodiments of the present disclosure, definitions of one or more terms that will be used in the document are provided below. For a person skilled in the art, it is understood that the definitions are provided just for the sake of clarity and are intended to include more examples in addition to the examples provided below.

The term “combined display device” refers to a display device created/built/formed by combining/connecting two or more display devices. The combined display device can be termed a display wall. The multiple display devices are combined such that they provide an experience of viewing content on a single large screen and thus, allows the user to view content of his choice on a large-size screen. Few examples of display devices can be television, mobile devices, commercial displays, display screens, PDAs, tablets, or the like.

The term “display device” refers to an individual display device that a user uses on a day-to-day basis to view content of his choice such as sports, entertainment, news, serials, web series, streaming video, comedy shows or the like. In context of the current disclosure, the display device includes a controller, one or more compatibility pins, and a user interface. These are exemplary components, but the disclosure may include other necessary components for implementing the current disclosure.

The term “combining” refers to include connecting/joining/positioning/placing multiple display devices to create a larger display device.

The term “compatibility” refers to compatibility between two or more display devices, in terms of functions, features, hardware, and/or software to provide seamless experience to the user. The display devices may have the same functions, features, hardware and/or software components but not necessarily.

The term “user” refers to a user who wishes to combine multiple display devices to make a large display device in order to view content of his choice/requirements. The user can be a consumer, can be a team member from a manufacturer of the display device, or can be any other user.

The term “existing display device” refers to a (prior) display device that the user already has at his home or at a different place where he wishes to add a new display device. The term “new display device” refers to a display device that is added later to the existing display device.

The term “user interface” refers to a user interface that allows a user to provide inputs and/or displays one or more notifications to the user. For example, one or more menu options are provided to the user to select, choose, or confirm. In another example, notification messages such as “please wait while we check the compatibility of the multiple display devices” are shown to the user. More details are provided below.

### Overview

There is a current need for larger display screens in televisions, mobile devices/tablets, and other consumer devices at a reasonable cost and in this light, the present disclosure is presented. The present disclosure presents an easy, efficient, affordable, and user-friendly approach to make a large display. The methods and systems allow users to combine multiple display devices at any time in an affordable manner. For example, the methods and systems allow the user to combine multiple display devices, say, 4 display devices at one time, i.e., meaning that the user has purchased 4 display devices of smaller sizes at reasonable cost, and he can combine these display devices to make a large display device. In another example, the methods and systems allow the user to combine multiple display devices at different times. In this scenario, the user already has one display device and later i.e., after 6 months, he can add a new display device to the existing display device to create a large display device. The user can continue to add new display devices to existing display devices to create a large display device. This way, the methods and systems provide a flexible approach to the user, to add new display devices based on his requirements and/or choices.

The present disclosure provides a flexible, modular, and user-friendly approach to form a huge display wall, where the users can add multiple display devices as and when they like and/or can afford. For example, if the users have money to spend, they can buy all display screens at once and form a huge display wall. In another example, if the users have budget constraints, they can first buy one display device and later say after a year, they can buy another display device, and then more display device can be added after some time, for example, 6 months. The proposed solution of the disclosure considers users dynamic choices/desires as they may change with time. For example, the users do not have to worry about buying all display devices from the same manufacturer, or these display devices do not necessarily need to have same features, functions, configurations, or the like. For example, if a user has a TV from a manufacturer say, Samsung and later he wishes to buy a display device from another TV manufacturer, say, Toshiba and wishes to add to the existing display device from Samsung, the disclosure allows the user to do so without any limitation. The multiple display devices are combined to provide a seamless user experience.

A display wall, formed by combining multiple display devices, is an output device i.e., hardware that displays content to one or more users according to their choices/preferences. The display wall may include hardware and/or software components required for implementing the disclosure. For example, the display wall includes one or more hardware components such as display devices having display screens, compatibility pins, ports, memory, and software components such as a controller, user interface, etc. The hardware and software components work in tandem with each other such that content of users' choices and/or preferences is displayed to them. The content displayed to the users is tangible in nature and hence the solution proposed in the disclosure provides tangible output and is not an abstract idea.

Allowing a user to form a large display wall (or otherwise forming a large display wall) in a modular and dynamic fashion is a technical solution to a long-standing problem of a static display wall or complex display walls that do not allow user to later add a display device of their choice, is not an abstract idea because of many reasons. Allowing a user to form a large display wall in a modular and dynamic fashion by combining multiple display devices at any stage is not an abstract idea because it is not merely an idea itself (e.g., it cannot be performed mentally or using pen and paper). Allowing a user to form a large display wall in a modular and dynamic fashion by combining multiple display devices is not abstract idea because it is not a fundamental economic practice (e.g., is not merely creating a contractual relationship, hedging, mitigating a settlement risk, etc.). Allowing a user to form a large display wall in a modular and dynamic fashion by combining multiple display devices is not an abstract idea because it is not a method of organizing human activity (e.g., managing a game of bingo). Allowing a user to form a large display wall in a modular and dynamic fashion is not an abstract idea because the methods and systems are not simply a mathematical relationship/formula but instead include checking compatibility of different display devices before displaying content to the user of their choices, preferences and/or requirements.

Allowing a user to form a large display wall in a modular and/or dynamic fashion is not an abstract idea because it enhances the user experience of viewing content which can be same and/or different content.

Allowing a user to form a large display wall in a modular and dynamic fashion is not an abstract idea because the disclosure requires one or more hardware components such as display devices having display screens, compatibility pins, ports, memory, and software components such as a controller, user interface, etc. The hardware and software components work in tandem with each other to display content on the large display.

Allowing a user to form a large display wall in a modular and dynamic fashion is not an abstract idea because the disclosed display wall allows for significant improvement to the technical fields of user experience, affordability, ease of use, better aesthetics aspect, compatible devices, flexible display walls, customer retention, multiple content or the like.

The disclosure clearly differentiates over the prior art by incorporating one or more features such as by embedding controller inside the display devices, providing flexibility to add display devices at later stages and/or in any possible configuration, checking compatibility of multiple display devices, allowing addition of the display devices from different manufacturers, sizes, features to be combined and many others as discussed in the disclosure.

### Exemplary Environment

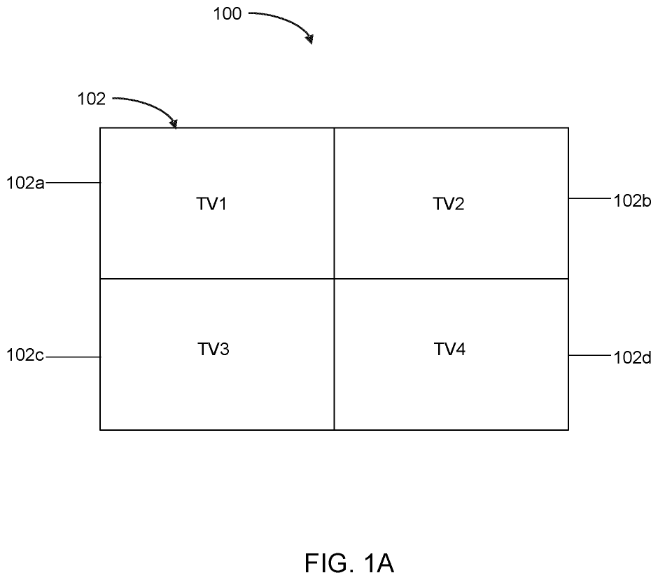

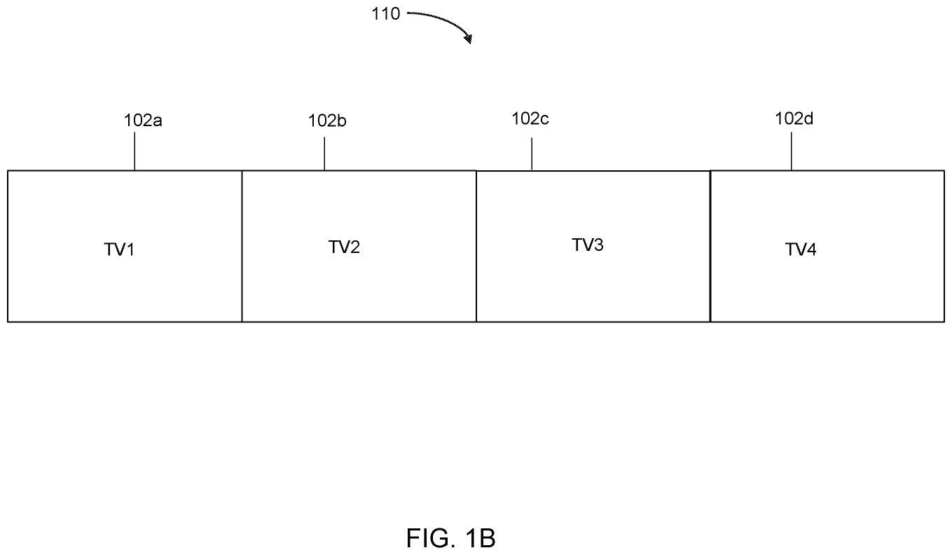

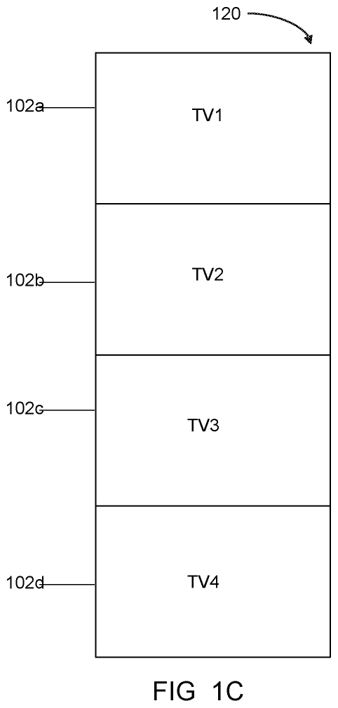

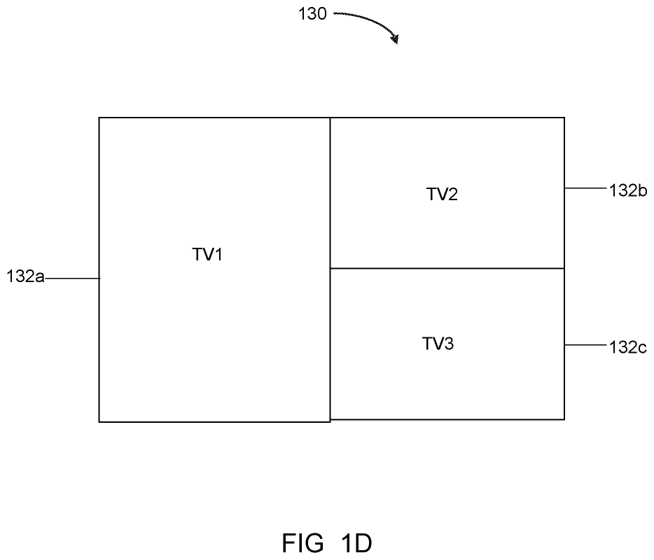

FIG. 1A illustrates an exemplary environment 100 in which various embodiments of the disclosure can be implemented. The environment 100 is shown to include a combined display device 102 which is built by combining multiple display devices such as 102a, 102b, 102c, and 102d, collectively 102. Numerous examples of the display devices 102 can be television, mobile device, portable device computers, streaming video control box by example the Apple TV, Roku, FireTv, devices, or a smart device, or the like. A user can view content of his choice using the display device such as TV serial, a movie, streaming video, YouTube videos, sports, entertainment shows, music, or the like. Each display device 102 includes an audio source for outputting audio, a video source for outputting video content, a display screen for displaying content to the user/rendering video, and a power source for providing power supply for functioning of the display device 102. Each display device 102 may further include one or more ports such as USB (Universal Serial Bus) port, HDMI (High-Definition Multimedia Interface) port, audio and video inputs, VGA (Video Graphics Array) port or the like. For simplicity, the disclosure is discussed with television as an example, but it is understood the disclosure can be implemented for other types of display devices 102 as mentioned above, known in the art, or later developed display devices.

As shown in FIG. 1A, the display devices 102 are combined in 2×2 matrix configuration i.e., where a total of 4 display devices are connected with 2 display devices such as 102a, and 102b (could be 102c and 102d) arranged in horizontal direction and 2 display devices arranged in vertical direction such as 102a and 102c (could be 102b and 102d) in vertical direction. Each display device 102 can be of the same size, different sizes or a combination thereof. Each display device 102 can be of size such as 24 Inches, 28 Inches, 32 inches, 42 Inches, 48 Inches, 55 Inches, 65 Inches or the like. These display devices 102a, 102b, 102c and 102d can be combined in other possible configurations such as 4×1, 1×4 and so on. As an example, FIG. 1B shows 4×1 configuration, marked as 110, where multiple display devices such as 102a, 102b, 102c and 102d are combined in horizontal direction. These devices 102 are arranged to make a combined display device such as 110. Similarly, 1×4 configuration is depicted in FIG. 1C where multiple display devices such as 102a, 102b, 102c and 102d are arranged/combined vertically to build a combined display device, marked as 120. These are a few exemplary configurations shown for understanding purposes, but there can be other possible configurations. The user can arrange these display devices 102a, 102b, 102c and 102d in any manner based on his comfort, requirement, preferred view or the like.

Although the combined display devices 102, 110 and 120 as shown in FIGS. 1A-1C, respectively include four display devices, the combined display devices 102, 110 and 120 can include more or lesser numbers of display devices. For example, a combined display device can be formed/created using 2 display devices, 3 display devices, 5 display devices, 8 display devices, 10 display devices, 20 display devices and so on. There can be any number of display devices to build a display wall without limiting the scope of disclosure. Further, the display devices forming a combined display device can be of same size or different sizes. For example, FIG. 1D shows a combined display device 130, where 3 display devices such as 132a, 132b and 132c are combined. The display device 132a is of a different size than the display devices 132b and 132c, whereas the display devices 132b and 132c are of the same size. As can be seen clearly, the display device 132a is of a larger size and display devices 132b and 132c collectively are of the same size as the display device 132a.

Referring back to FIG. 1A, each display device 102a, 102b, 102c and 102d can have the same functions, features, components, and the like. But in another example, each display device 102a, 102b, 102c and 102d can have slightly different features, functions and so on. For example, all display devices 102a, 102b, 102c, 102d can have Bluetooth, and/or Wi-Fi functionalities. While in another example, the display device 102a, 102b can have Bluetooth functionality, the display device 102c can have Bluetooth and Wi-fi and the remaining display device 102d can have Wi-Fi. In another example, each display device 102a, 102b, 102c, 102d may have the same resolution or may have a different resolution. Each display device 102a, 102b, 102c and 102d may be from the same manufacturer or from different manufacturers. Each display device 102a, 102b, 102c and 102d may be of the same type of display model, or they may be different display models.

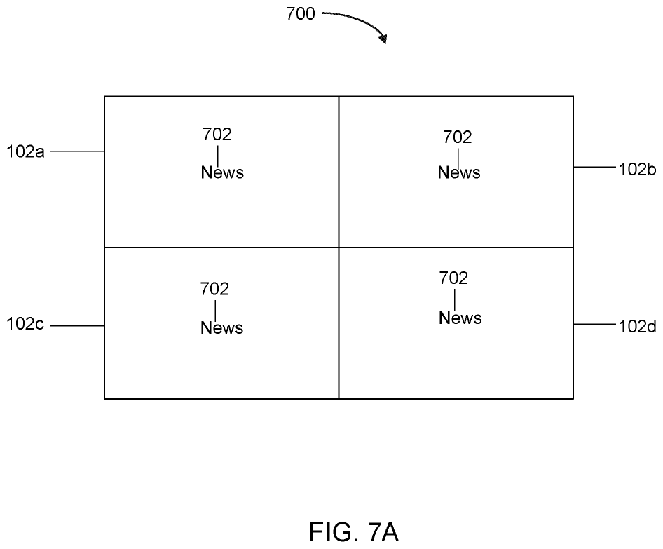

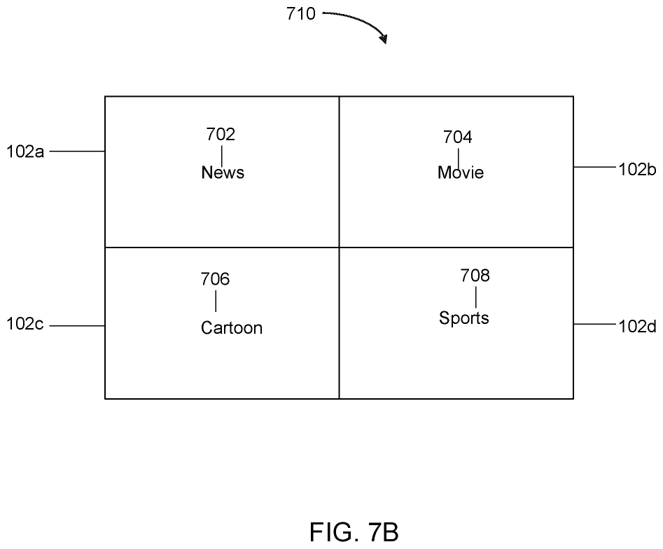

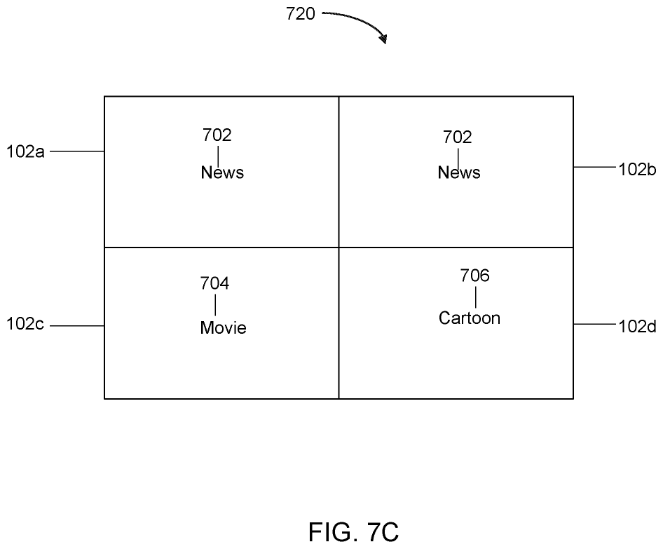

Each display device 102a, 102b, 102c and 102d is a modular display device that can act as an individual/independent display device or can also be connected/combined with other display devices to form a combined display device/display wall. Further, each display device 102a, 102b, 102c and 102d can display the same content such as news, whereas each display device 102a, 102b, 102c and 102d can be configured to display different content. But in additional examples, some display devices such as 102a, 102b can display the same content, while 102c can display different content and 102d displays different content (See FIGS. 7A-7C). The combined display device 102 can be configured by the user in any possible manner.

Each display device 102a, 102b, 102c and 102d can be connected to a power supply separately or share one power supply. The combined display device 102 can be connected to one or more video or audio sources. The combined display device 102 is connected to an input source of display device 102a. For example, the combined display device 102 is connected to video source or audio source of the display device 102a. Here, the combined display device 102 receives HDMI signals of the display device 102a, where HDMI port of the display device 102a is connected to an external device such as Set up box which provides HDMI signals to the display device 102a that further provides HDMI signals to other display devices such as 102b, 102c and 102d in connection. Similarly, the combined display device 102 can be connected to input sources of other display devices such as 102b, 102c, and 102d. In alternate implementations, the combined display device 102 can be connected to multiple sources such as video source of the display device 102a and an audio source of the display device 102c.

Each display device 102a, 102b, 102c, 102d can be LED, LCD, OLED, screen, projectors tiles, cubes, or the like. These display devices 102a, 102b, 102c, 102d can be combined in any configuration to form a rectangle or square.

The combined display device 102 can be used at any places such as homes, stadiums, airports, large public venues, college campuses, outdoor advertising, conference & meeting rooms, clubs, pubs & restaurants, sport venues or the like. These are a few examples, but the combined display device 102 can be used/built at any place where the content needs to be viewed on large screens.

In context of the current disclosure, each display device 102a, 102b, 102c and 102d includes a controller, one or more compatibility pins and a user interface (although not shown here). These compatibility pins are called electrical mating pins, electrical connection pins, or interlocking pins. The controller manages content to be displayed on multiple display devices. The compatibility pins provide interconnection between different display devices 102a, 102b, 102c and 102d. The user interface displays various notifications or messages to the user and allows the user to provide an input for implementing the present disclosure. In implementation, a user combines multiple display devices such as 102a, 102b, 102c and 102d via respective compatibility pins. Once each display device 102a, 102b, 102c and 102d is connected to each other, compatibility of each display device 102a, 102b, 102c and 102d is checked, and confirmation is displayed to the user via the user interface and/or menu. After this, content is displayed to the user on the combined display device 102 of his choice/requirements. This way, the user can enjoy viewing content on a large screen i.e., using multiple display devices and this does not require him buying one large expensive screen. More details will be discussed in subsequent figures.

### Exemplary System

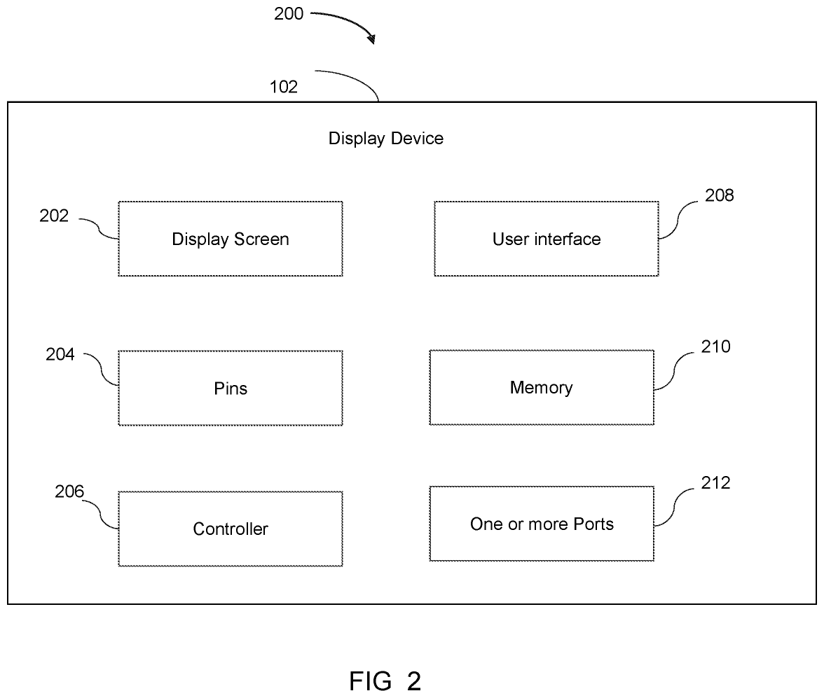

FIG. 2 is a block diagram 200 illustrating various components of an exemplary display device such as 102a. Reference to other figures can be made. As shown, the display device 102a includes a display screen 202, one or more compatibility pins 204, a controller 206, a user interface 208, a memory 210 and one or more ports 212. The components 202-212 are connected to each other via a conventional bus or a later developed protocol. Further, the components 202-212 communicate with each other for performing various functions of the present disclosure. The display device 102 may further include additional component(s) as required to implement the present disclosure.

Similar to the display device 102a, each display device 102b, 102c and 102d can have the same components 202-212 as discussed above. For example, the display device 102b includes a display screen, compatibility pins, a controller, a user interface, a memory, and one or more ports. Similarly, the display device 102c includes a display screen, compatibility pins, a controller, a user interface, a memory, and one or more ports. For example, the display device 102d includes a display screen, compatibility pins, a controller, a user interface, a memory, and one or more ports. For easy discussion, structural and implementation details of the display device 102a will be discussed but it will be understood that the same explanation applies to other display devices 102b, 102c and 102d. Any variations to the implementation details can be incorporated.

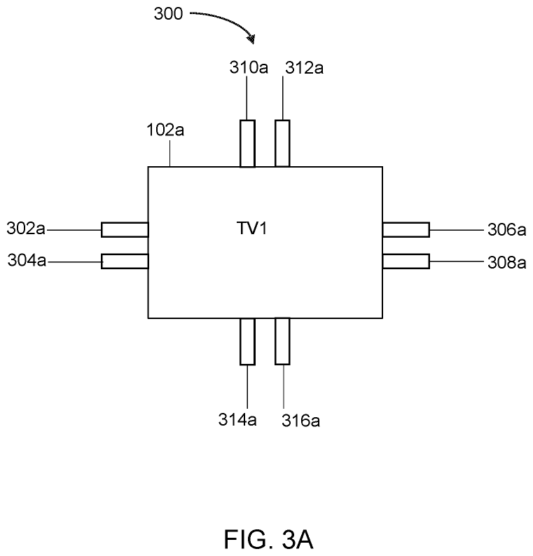

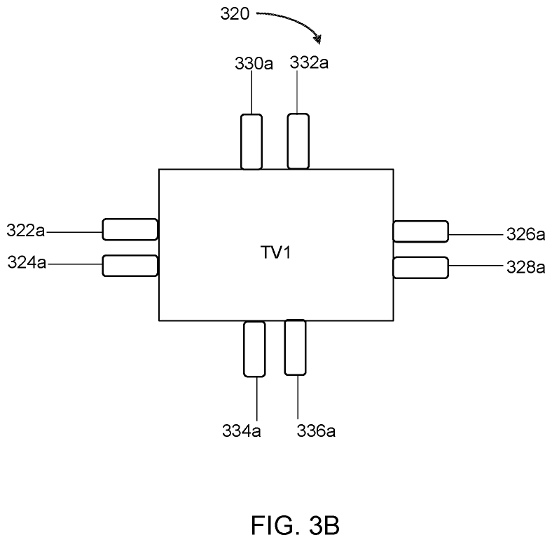

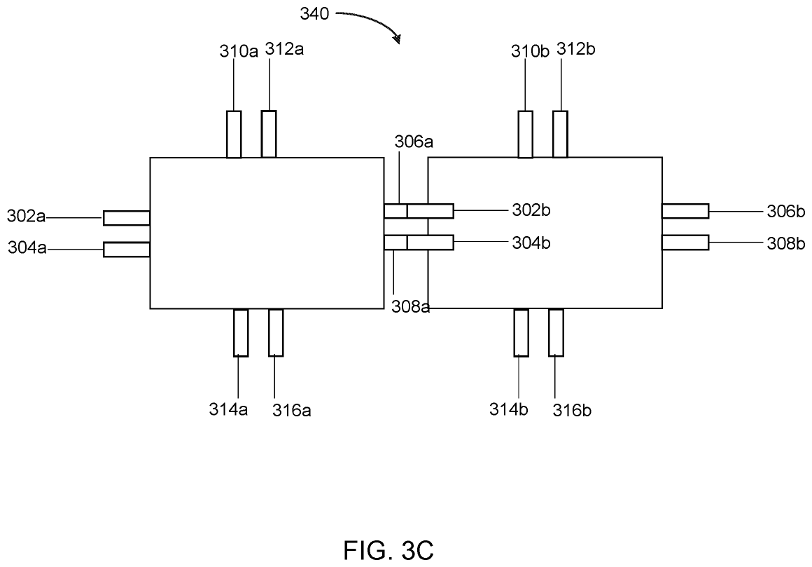

The display device 102a can be any device such as television which a user typically uses for viewing content. The display screen 202 displays content to the user in a desirable format. The display screen 202 can have any resolution such as 1080 pixels or 4k resolution and so. The compatibility pins 204 are the pins that provide electrical connection between multiple display devices such as 102a and another display device such as 102b, although not shown in FIG. 2. These pins 204 can be present on each side of the display device 102a. One exemplary configuration 300 is shown in FIG. 3A, where the display device 102a includes two pins on each side of the display device 102a. As clearly seen in FIG. 3A, the display device 102a includes two pins such as 302a, 304a on left side of the display device 102a, two pins such as 306a, 308a on right side of the display device 102a, two pins such as 310a, 312a on top side of the display device 102a and two pins such as 314a, and 316a on bottom of the display device 102a. In alternative embodiments, these pins 302a-316a can be provided on one side, two sides, or three sides of the display device 102a. For example, these pins 302a-316a can be provided just on the right side of the display device 102a. In another example, these pins 302a-316a can be provided on top and bottom sides of the display device 102a. In further examples, these pins 302a-316a can be provided on the left and right sides of the display device 102a. As can be seen in FIG. 3A, the pins 302a-316a are rectangle in shape but these pins 302a-316a can be of other shapes and sizes such that they allow easy interconnection between multiple display devices. One such different pin configuration is shown in FIG. 3B (marked as 320), where the display device 102a includes two pins of rectangle shape with round edges. The display device 102a includes pins on all sides including left (322a, 324a), right (326a, 328a), top (330a, 332a), and bottom (334a, 336a) of the display device 102a. The number of pins as shown in FIGS. 3A-3B on each side is two but there can be more pins provided on each side of the display device 102a without limiting the scope of the disclosure. The pins 302a-316a and 322-336a include a locking mechanism to interlock two display devices 102a and 102b when the two display devices 102a and 102b are placed close to each other or when they are in physical contact with each other (see FIG. 3C). In the implementations above, the compatibility pins 302a-316a and 322-336a are shown to be interlocked automatically. But in alternate embodiments, the compatibility pins 302a-316a and 322-336a can be connected to each other via a cable or with Bluetooth communication to provide connection between multiple display devices such as 102a and 102b.

The pins 204 are interconnected to the controller 206 and to the overall circuitry of the display device 102a, although not shown. These pins 204 can be recessed so that they are only seen when the display devices such as 102a and 102b are connected. The pins 204 cause electrical connection between the display devices that activate the controller 206. The pins 204 can be used for data sharing as well.

The controller 206 performs all functionalities required for displaying content to the user on multiple display devices. Few examples include managing content to be displayed across multiple display devices, managing display settings, arranging, scaling, and adjusting the content to be displayed on all display devices, calibration between video and audio and so on. For example, the controller 206 splits one video signal into multiple outputs such as 2×2, 1×2, 2×1 and so on, depending on the number of display devices in connection. For example, the controller 206 splits one audio signal into multiple outputs such as 2×2, 1×2, 2×1 and so on. In context of the current disclosure, the controller 206 gets activated when the two display devices are connected via the compatibility pins 204. The controller 206 determines the total number of display devices in connection, and this is determined based on a signal input from each display device in connection. The controller 206 checks for compatibility of the multiple devices before displaying content. Once that is done, the controller 206 displays content to the user on multiple devices such that the user can smoothly view the content on a large display device.

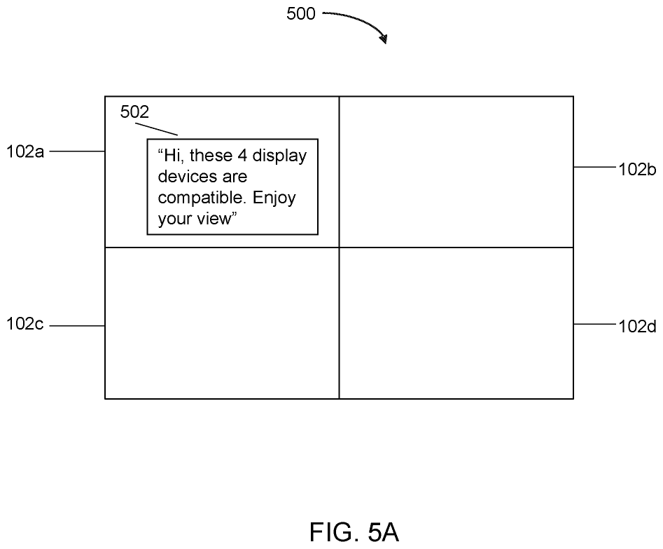

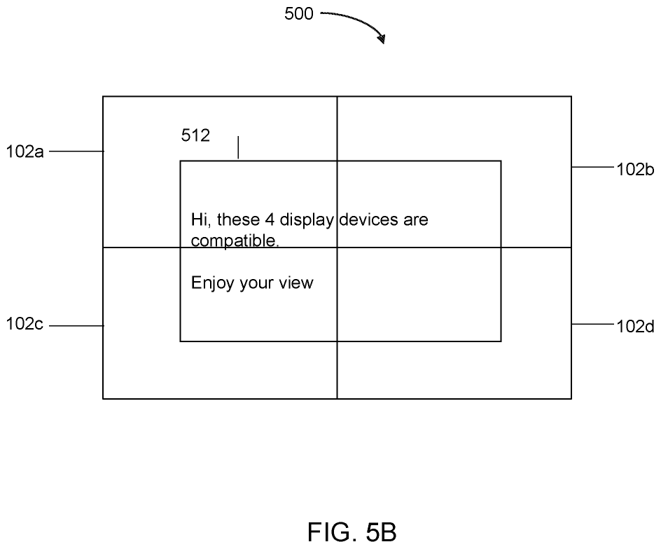

The user interface 208 displays one or more messages to the user as well as allowing the user to provide an input for implementing the present disclosure. The user interface and/or menu 208 may display one or more messages related to compatibility of the multiple devices such as confirmation messages. The user interface 208 further provides one or more options or choices to the user for selection. The user can provide his input to the same. The user interface 208 can be controlled using voice command, touch command, able to be mouse-driven or via other selection types by the user. The user interface and/or menu 208 can switch from one display device to another display device. The user interface 208 can be big enough to be displayed on all display devices (see FIGS. 5A-5B). The user interface 208 can be displayed on three display devices, two display devices and so on. These display devices can be controlled by the user interface 208.

The memory 210 stores various information or details required for implementing the current disclosure. For example, the memory 210 stores user details, his choices, preferences or the like. The memory 210 may store details associated with the display device 102a such as size, type of display device, software version, configuration details including software and hardware, manufacturer details or the like. The controller 206 retrieves the relevant information from the memory 210 as and when required.

The one or more ports 212 can be USB port, audio video ports, VGA port, HDMI port, or the like. These ports 212 are communicatively coupled to an external device such as HDMI device via a cable for example. These ports 212 take input signal from the external device such as set-up box and provide to the controller 206 for further processing. These ports 212 act as a communication medium between the external device and the controller 206.

Additionally, the display device 102a may have a remote control or an application for a portable device to use for operating the display device 102 such as changing channels, increasing or decreasing volume, or the like.

### Implementation

An implementation scenario will be discussed for better understanding, where a display wall is built using two display devices such as 102a and 102b. In this scenario, it is considered that a user wishes to build a display wall 340 (see FIG. 3C) using the display devices 102a and 102b which are of the same sizes, but these can be of different sizes. It is considered that the user already has the display device 102a in his living room and he wishes to add a new display device such as 102b. Each display device 102a, 102b can be mounted using one mounting bracket or multiple brackets so that the display devices 102a and 102b are in physical contact with each other.

For example, the user first places the display device 102b near the display device such as 102a such that the compatibility pins 302b and 304b of the display device 102b interconnect with the compatibility pins 306a and 308 of the display device 102a, respectively as can be seen in FIG. 3C. The pins 302b, 304b, 306a and 308a are visible when the display devices 102a and 102b are combined and/or when are connected to each other. The display device 102b is received to one side of the display device 102a, for example, right side of the display device 102a as shown in FIG. 3C. The right side of the display device 102a is connected to the left side of the display device 102b. The display devices 102a and 102b are connected to each other such that the electrical connections on each of the display devices 102a and 102b are connecting one to another via the pins 302b, 304b, and 306a and 308a. Some of the pins may be unused on top and bottom of the display wall and also remain unused on one side of the display wall. As can be clearly seen, the pins on the interior surfaces of the 2 displays devices are in contact (interconnected) with each other and this is dependent on the configuration/arrangement of the display devices.

Continuing with the example of display wall 340 as shown FIG. 3C, pins such as 302a, 304a, 310a, 312a, 314a and 316a of the display device 102a are unused. Similarly, pins such as 306b, 308b, 310b, 312b, 314b and 316b of the display device 102b are unused. This way, the display device 102b is added and paired with the existing display device 102a. When the desired number of display devices are added (with connections one to another) the user can provide the information and can confirm that this process is completed by either an audio input or via a user interface input. For example, the user can press a designated button on the display device 102a or the display device 102b. Otherwise, the user can confirm it by pressing a touch button given on the display device 102a or 102b. In alternate embodiments, the display device 102b confirms that the display device 102b has been added with an audio or text message or through a connected application running on a portable device.

Post interconnection of the pins of these display devices 102a and 102b, controller 206 of both the devices 102a and 102b are activated and communicate with each other. Here, one display device such as 102a can act as a master display device and can proceed forward with the processing. Accordingly, the controller 206 of the display device 102a acts as a master and determines the total number of display devices in connection, in this case, the total number of display devices is 2. The controller 206 then checks for compatibility of the display device 102b with the display device 102a based on the pre-defined parameters. Numerous examples of the pre-defined parameters can be size, resolution, brightness, features, functions, or the like. For example, the controller 206 may check whether the display device 102b is of the same size as the display device 102a. Based on that, the controller 206 confirms the compatibility of the new display device 102b to the user. The controller 206 can send a notification to the user which can be in the form of an audio message, displaying a text message via the user interface 208. In the case of the text message, the controller 206 displays the user interface with the text message which can be displayed on the combined display wall 340 or on an individual display device 102a or 102b. The user interface 208 is presented to the user with multiple options for configuring the display wall. For example, the user interface 208 provides an option to the user to select a video source-whether he wishes to connect to a video source 1 of the display device 102a or video source 2 of the display device 102b. In another example, the user interface 208 provides an option to the user to select an audio source-whether he wishes to connect to audio source of the display device 102a or audio source of the display device 102b. The user interface 208 is further provided with one or more choices or options for configuration such as position of combined image, color saturation, brightness, contrast, resolution, utilization of parts of the display devices or the like. These are a few examples, more options on the user interfaces can be included that allow the user to configure the display wall 340 according to his requirements and/or choices. The user can select the desired option either by clicking that option via a remote control of the display device 102a, via a mobile app, via an audio input or via touch input on the display device 102a or through a connected application running on a portable device.

This way, the user provides his input to the displayed options or choices. Based on the input, the controller 206 receives the input from the user, processes the input, makes the necessary adjustments, and displays the content to the user on the display wall 340 according to his requirements and/or preferences. This way, the user can view the content of his choice on a bigger display i.e., the combined display device 340 and can enjoy a theatre experience at home or can provide a commercially usable display area for any video source.

In some examples, the user is provided with an option to uncombine any display device such as 102a and 102b from the display wall 340. In such a scenario, the uncombined display device act as an individual display device. This will allow the user to have multiple video sources displayed simultaneously on the display wall. The uncombining does not require the user to manually uncombine the devices via pins or disconnect pins from each other, however, the user can be provided with an option on the user interface, and he can remove the display device from pairing. The controller 206 receives the input from the user and performs further processing.

Any display device can act as master display device or others can act as slave display device. This can be done via user interface 208. The master display device can be the display device with user interface, input, and output connectors. The master display device can be the existing display device and the new display device can act as a slave display device. These are a few exemplary configurations but other variations to these can be implemented.

The user can continue to add as many display devices as he wishes to and the process of checking the compatibility of one display device with another display device is performed when a display device is interconnected (via the connection pins) to another display device. A video message or text message can be displayed on both display devices to confirm compatibility. This process continues for each display device that is added by the user. Display devices from different manufacturers or from the same manufacturer but different models may be added as long as they are compatible with one another.

### Exemplary Flowcharts

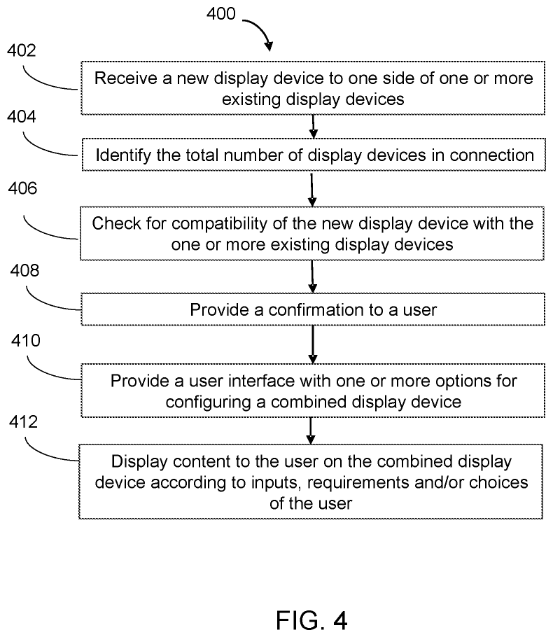

FIG. 4 is a method flowchart 400 for allowing a user to combine multiple display devices to create a combined display device, referred to as a display wall. Specifically, the method 400 is for combining a new display device with prior existing one or more display devices to make a single combined display device. Each display device includes a controller embedded within the display device, further includes two or more compatibility pins on one or more sides of the display device and a user interface. The method 400 can be implemented using one or more components of the display device such as a controller.

The method 400 begins when a user wishes to combine multiple display devices. In this case, it can be considered that the user already has a display device, and he wishes to add a new display device to an existing display device. The user connects the new display device to the existing display device by placing the new display device adjacent to the existing display device and connecting them via compatibility pins. The new display device can be connected to any side of the existing display device. At 402, the new display device is connected/received to one side of the existing one or more display devices via the two or more compatibility pins. The new display device is paired with the existing one or more display devices via the two or more compatibility pins and finally the new display device is added to the existing one or more display devices to make it a combined display device. Once the new display device is added, the user can confirm the addition via an audio input, via a touch input, via pressing a designated button on the display device or a remote control of the display device. In alternate examples, once the display devices are connected to each other, a user interface is presented automatically confirming successful connection. The user interface may display a message indicating another display device is in connection.

At 404, the total number of display devices in connection is identified, after the new display device is added to the existing one or more display devices. For example, in this case, the total number of display devices is two.

Before displaying content, it is checked whether the new display device is compatible with the existing one or more display devices, based on one or more pre-defined parameters at 406. The compatibility check can be performed to check whether the existing display device and the new display device can be combined to display content to the user. In some examples, the compatibility is checked in terms of circuitry, compatibility pins including but not limited to other components of the display devices.

Once the compatibility check is completed, a confirmation is provided to the user at 408. The confirmation can be given via a message displayed on the user interface. One such exemplary message is shown in FIG. 5A. As shown, a message 502 is shown on a user interface of the display device 102a, where four display devices such as 102a, 102b, 102c and 102d are combined to form a display wall 500. While the message 502 can be shown on a user interface and/or menu of the combined display device 500 such that the message 512 via user interface is a part of all display devices 102a, 102b, 102c and 102d, see FIG. 5B.

At 410, another user interface is provided to the user with one or more options to the user for configuring the combined display device and further allowing the user to make adjustments. For example, the user can be provided with multiple options for video sources such as video source of the display device 102a or video source of the display device 102b. Similarly, the user can be provided with multiple options for audio sources such as audio source of the display device 102a or audio source of the display device 102b. The user can provide his input and select a desired option. This way, an input from the user on the one or more displayed options is received. At 412, finally, the content is displayed on the combined display device according to inputs, requirements and/or preferences of the user.

In some scenarios, a display wall 700 can be configured such that each display device of the combined display device displays the same content. One such example is shown in FIG. 7A, where each display device 102a, 102b, 102c and 102d displays the same content i.e., news (marked as 702) is displayed. In other example scenarios, a display wall 710 can be configured such that each display device of the combined display device displays different content. One such example is shown in FIG. 7B, where each display device 102a, 102b, 102c and 102d displays different content. As shown, display device 102a displays news (marked as 702), the display device 102b displays movie (704), the display device 102c displays cartoon (706), and the display device 102d displays sports (708). In additional example scenarios, a display wall 720 can be configured such that one or more display devices of the combined display device display the same content, while the remaining display devices display different content. One such example is shown in FIG. 7C, where some display devices such as 102a, 102b show the same content, and the display devices 102c and 102d display different content. As shown, display devices 102a, 102b display news (marked as 702), 102c displays a movie (704), and 102d displays cartoon (706).

There can be some situations where the user wishes to uncombine a display device from the display wall due to multiple reasons. To cater to such situations, the method 400 allows the user to uncombine a display device from the display wall such that the uncombined display device can act as an individual display device. The user can uncombine the display device of his choice without requiring him to disconnect the display device via the pins. For example, an option can be provided to the user via a user interface and/or menu of the display wall.

The method 400 includes confirming the compatibility before content is displayed using the combined display device. The method 400 includes receiving a confirmation when the new display device is added successfully.

The method 400 can be implemented in the form of a non-transitory computer-readable medium. The non-transitory computer-readable medium stores instruction, which when executed by one or more processors cause the one or more processors to: execute blocks 402, 404, 406, 408, 410, and 412.

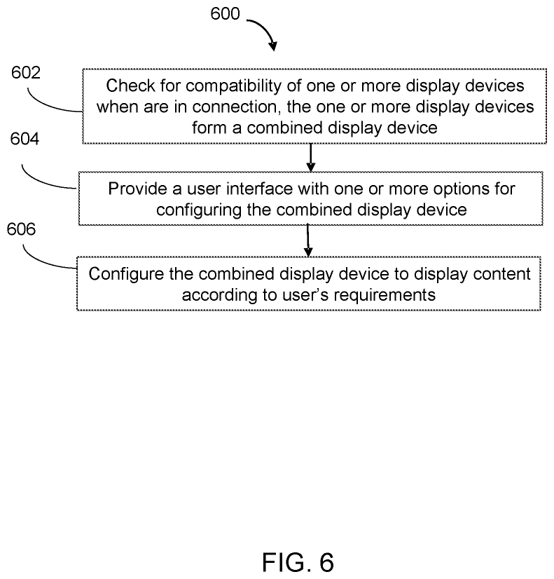

FIG. 6 is a method flowchart 600 for allowing a user to configure a display wall using multiple display devices. The method 600 includes checking compatibility of multiple display devices forming the display wall before displaying content to the user. The display wall includes two or more display devices, where each display device is connected to each other via compatibility pins. In this example, it is considered that the two or more display devices are already in connection with each other via the compatibility pins.

The method 600 begins when a user wishes to view content on the display wall. At 602, compatibility of each display device is checked, based on one or more pre-defined parameters as discussed above. The compatibility of each display device is checked before displaying content to the user. Upon checking, compatibility of each display device is confirmed to the user. Based on the compatibility check, a user interface is displayed on at least one display device of the combined display device with one or more options for configuration at 604. An input from the user on the one or more displayed options is received. Based on the input from the user, the display wall is configured such that the display wall displays content according to the requirements and/or preferences of the user at 606. This way, the user can enjoy viewing content of his choice.

The method 600 can be implemented in the form of a non-transitory computer-readable medium. The non-transitory computer-readable medium stores instruction, which when executed by one or more processors cause the one or more processors to: execute blocks 602, 604, and 606.

The method 600 allows the user to configure the display wall or otherwise configure a display wall when multiple display devices are connected are connected to each other via compatibility pins such that the display wall displays content according to the requirements and/or preferences of the user.

The present disclosure allows users to add one or more new display devices to existing display devices as and when it is needed. This way, the present disclosure provides a very flexible approach to the user. For example, initially, a user has one display device and later he wishes to purchase more display devices such as two, he can directly purchase and add the new display devices to the existing display device. The user can continue adding the display devices based on his requirements.

The present disclosure allows a user to have a relatively low-cost display device and later make it a larger display device by combining with other compatible display devices at an affordable cost. The present disclosure allows the user to upgrade their display devices without replacing the existing display device. At the same time, the disclosure allows the manufacturer to market this technology to the user/buyers with a substantial advantage. Additionally, the disclosure provides an additional sales opportunity to manufacturers to sell the user multiple display devices instead of one display device, thus doubling or quadrupling, etc., their sales revenue.

The present disclosure also addresses the issue of the HDCP encrypted handshake and Edid information transfer and makes sure that when the display devices are linked together, the circuitry produces one HDMI output signal that is compatible with the handshake. This HDMI output can be designated by the circuitry and directed to one of the outputs on a selected display.

The present disclosure can be implemented in the form of an app which can be downloaded on a mobile device. The app allows the user to control the functionality of the combined display device as well as allows the user to provide input, select options and provide a user interface/menu. Additionally, one or more messages can be displayed on the app itself. This app may also assist in the setup of the multiple displays.

The disclosure provides a user-friendly approach to add display devices at various stages and further allows the user to add display devices of any size to form a large display wall.

The disclosure proposes a controller, which is embedded inside the display device, thereby eliminating the need for an external hardware device or controller which adds an additional layer of complexity to the overall system due to multiple cables. As a result, the user does not have to compromise on aesthetics.

The methods and systems provide flexibility to the user to select and choose an audio or video source from multiple display devices that he wishes to connect with. As a result, the video and audio source display a combined image and audio, respectively on the multiple display devices. This allows the user to place the cabling connected to the display wall in the most desirable location.

For implementing the present disclosure, the disclosure needs at least one prior existing display device, at least one new display device, at least one pre-defined parameter for checking compatibility, at least one compatibility pin for connection and/or compatibility, at least one option for selection, viewing, making adjustments and so on. The disclosure can include more than one as discussed above in various implementations.

The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

The foregoing is illustrative only and is not intended to be in any way limiting. Reference is made to the accompanying drawings, which for a part hereof. In the drawings, similar symbols typically identify similar components, unless context dictates otherwise.

Note that the functional blocks, methods, devices, and systems described in the present disclosure may be integrated or divided into different combinations of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement distinct functions described herein. For example, the present application may be implemented using a general purpose or dedicated processor running a software application through volatile or non-volatile memory. Also, the hardware objects could communicate using electrical signals, with states of the signals representing different data.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for allowing a user to combine a new display device with at least one prior existing display device to make a single combined display device, each display device of the combined display device comprising a controller embedded within the display device, and further comprises a plurality of compatibility pins on one or more sides of the display device, the method comprising:
receiving the new display device to one side of the at least one prior existing display device via the plurality of compatibility pins;
adding the new display device to the at least one prior existing display device to make a combined display device;
checking for compatibility of the new display device with the at least one prior existing display device, based on at least one pre-defined parameter, wherein the pre-defined parameter corresponds to a size, a resolution, a brightness level, a feature, or a function;
automatically providing a user interface on at least one display device of the combined display device to confirm the compatibility of the new display device with the at least one prior existing display device before content is displayed on the combined display device, wherein the user interface displays one or more messages related to compatibility of the new display device and the at least one prior existing display device, and at least one option for selection;
receiving an input from the user on the at least one displayed option; and
displaying content on the combined display device according to the input from the user.

2. The method of claim 1, wherein each display device of the combined display device displays the same content.

3. The method of claim 1, wherein each display device of the combined display device displays different content.

4. The method of claim 1, wherein at least one display device of the combined display device displays the same content, while the remaining one or more display devices display different content.

5. The method of claim 1, further comprising identifying the total number of display devices in connection, when the new display device is added to the at least one prior existing display device.

6. The method of claim 1, further comprising allowing the user to configure the combined display device.

7. The method of claim 6, further comprising allowing the user to connect to any video or audio source of the combined display device.

8. The method of claim 1, further comprising providing a user interface to the user with at least one choice to make adjustments.

9. The method of claim 1, further comprising confirming the compatibility via a user interface, before the content is displayed using the combined display device.

10. The method of claim 1, further comprising receiving an information from the user when the new display device is added successfully.

11. The method of claim 1, where each of the display devices is of different sizes.

12. The method of claim 1, where each of the display devices are from different manufacturers.

13. A display wall, comprising:
a plurality of display devices forming a combined display device, wherein each display device comprises:
a controller embedded inside the display device for controlling functionality of the display device, the controller checks for compatibility of each display device, based on at least one pre-defined parameter, wherein the pre-defined parameter corresponds to a size, a resolution, a brightness level, a feature, or a function;
at least one compatibility pin provided on at least one side of the display device such that the at least one compatibility pin is communicatively coupled to controller inside the display device, wherein the at least one compatibility pin provides connection between the plurality of display devices and compatibility between the plurality of display devices; and
a user interface for automatically displaying at least one message based on the compatibility of between the plurality of display devices before content is displayed on the combined display device and further allowing a user to provide input to configure the combined display device to view content according to preferences of a user.

14. The display wall of claim 13, wherein at least one compatibility pin is visible when the plurality of display devices is connected.

15. The display wall of claim 13, wherein the user interface provides at least one option to the user to make adjustments.

16. The display wall of claim 13, wherein the controller identifies the total number of display devices in connection, when a new display device is added to the plurality of display devices.

17. The display wall of claim 13, wherein the controller confirms the compatibility before content is displayed on the combined display device.

18. The display wall of claim 13, wherein each display device displays the same content or different content.

19. A method for configuring a combined display device comprising multiple display devices which are connected to each other via compatibility pins, the method comprising:
checking for compatibility of each display device in connection, based on at least one pre-defined parameter, wherein the pre-defined parameter corresponds to a size, a resolution, a brightness level, a feature, or a function;
automatically displaying a user interface on at least one display device of the combined display device to confirm the compatibility of the new display device with the at least one prior existing display device before content is displayed on the combined display device, wherein the user interface displays one or more messages related to compatibility of the new display device and the at least one prior existing display device, and at least one option for configuring the combined display device;
receiving an input from a user on the at least one displayed option; and
configuring the combined display device to display content according to preferences of the user.

20. The method of claim 19, further comprising confirming the compatibility to the user.
